(19) United States
(12) Patent Application Publication
(10) Pub. No.: US 2012/0052907 A1
(43) Pub. Date: Mar. 1, 2012

(54) Hands-Free, Eyes-Free Mobile Device for In-Car Use

(75) Inventors: James C. Gilbreath, Milpitas, CA (US); Todd F. Mozer, Los Altos Hills, CA (US)

(73) Assignee: SENSORY, INCORPORATED, Sunnyvale, CA (US)

(21) Appl. No.: 12/871,520

(22) Filed: Aug. 30, 2010

(51) Int. Cl. H04W 4/04; H04W 68/00; G10L 21/00; H04M 1/00

(52) U.S. Cl. 455/556.1; 455/569.2; 455/567; 704/275; 704/E21.001

(57) ABSTRACT

In one embodiment, a method determines an event at a mobile device and a movement value for a speed of movement of the mobile device based on the event. The movement value is compared to a threshold. If the movement value has passed the threshold, the method enables a mode such that the mobile device is configured to announce information to a user of the mobile device and configured to receive an audible command from the user of the mobile device.

### BACKGROUND

Particular embodiments generally relate to mobile devices and more specifically to a hands-free, eyes-free mode for the mobile device.

When driving a car, the user may receive a telephone call. If the user answers the call, the user takes his/her hand off the steering wheel and also diverts his/her eyesight to the mobile device to answer the call, which is very dangerous. Also, laws exist that prohibit the use of mobile devices while driving. Thus, a user should pick up the mobile device and answer the call in the above manner.

One option for the user is to use a Bluetooth headset to answer the call. However, in this case, the user must press a button on the Bluetooth headset to answer the call. Further, in most cases, the user would pick up the mobile device and look at the display to see who is calling. This scenario is also dangerous because the user is either taking his/her hands off the steering wheel of the car to answer the call using the Bluetooth headset or diverting his/her eyesight to look at the mobile device. Further, Bluetooth headsets are an added expense for the user.

In another example, the mobile device's accelerometer may be used to activate the mobile device. For example, by the user taking the mobile device and moving it up to his/her ear, a telephone application may be turned on. In this case, the acceleration of the mobile device in a certain direction is used to turn on the telephone application. However, in this case, the user is still handling the mobile device, which requires the user to take his/her hand off the steering wheel and his/her eyes off the road.

### SUMMARY

In one embodiment, a method determines an event at a mobile device and a movement value for a speed of movement of the mobile device based on the event. The movement value is compared to a threshold. If the movement value has passed the threshold, the method enables a mode such that the mobile device is configured to announce information to a user of the mobile device and configured to receive an audible command from the user of the mobile device.

In one embodiment, a computer-readable storage medium contains instructions for controlling a computer system to perform a method. The method determines an event at a mobile device and a movement value for a speed of movement of the mobile device based on the event. The movement value is compared to a threshold. If the movement value has passed the threshold, the method enables a mode such that the mobile device is configured to announce information to a user of the mobile device and configured to receive an audible command from the user of the mobile device.

In another embodiment, an apparatus includes one or more computer processors and a computer-readable storage medium comprising instructions for controlling the one or more computer processors to perform a method. The method determines an event at a mobile device and a movement value for a speed of movement of the mobile device based on the event. The movement value is compared to a threshold. If the movement value has passed the threshold, the method enables a mode such that the mobile device is configured to announce information to a user of the mobile device and configured to receive an audible command from the user of the mobile device.

The following detailed description and accompanying drawings provide a better understanding of the nature and advantages of the present invention.

### BRIEF DESCRIPTION OF THE DRAWINGS

FIG. 1 depicts an example of a mobile device according to one embodiment.

FIG. 2 depicts a more detailed example of a mode controller according to one embodiment.

FIG. 3 depicts a simplified flowchart of a method for enabling the hands-free, eyes-free mode according to one embodiment.

FIG. 4 depicts a simplified flowchart of a method for answering a telephone call using the hands-free, eyes-free mode according to one embodiment.

FIG. 5 depicts a simplified flowchart of a method for receiving voice commands in the hands-free, eyes-free mode according to one embodiment.

FIG. 6 depicts a simplified flowchart of a method for processing a second call while a first call has been connected according to one embodiment.

### DETAILED DESCRIPTION

Described herein are techniques for a hands-free, eyes-free mode for a mobile device. In the following description, for purposes of explanation, numerous examples and specific details are set forth in order to provide a thorough understanding of embodiments of the present invention. Particular embodiments as defined by the claims may include some or all of the features in these examples alone or in combination with other features described below, and may further include modifications and equivalents of the features and concepts described herein.

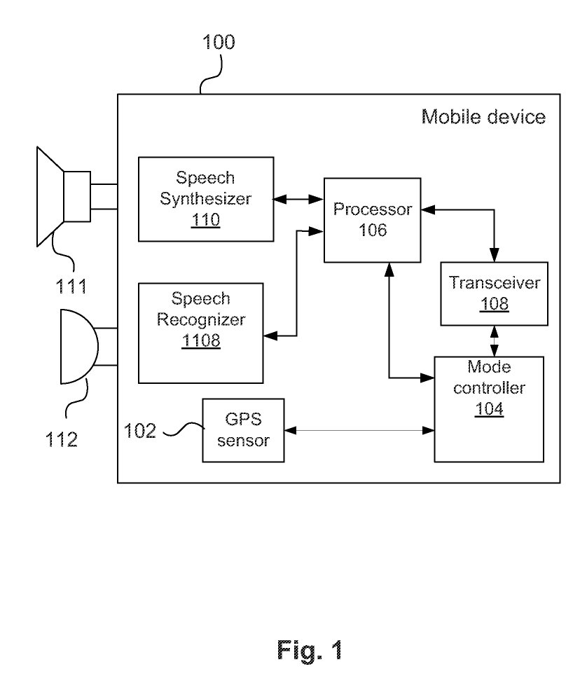

FIG. 1 depicts an example of a mobile device 100 according to one embodiment. Mobile device 100 may be a device that can receive or make telephone calls using a transceiver 108. For example, mobile device 100 includes a cellular telephone, personal computer, laptop computer, personal digital assistant (PDA), tablet computer, and other mobile devices that can receive or make calls.

Particular embodiments use a mode that enables a user to operate mobile device 100 in a hands-free and eyes-free manner. The hands-free manner is where the user can operate mobile device 100 without touching mobile device 100 with his/her hands during operation. The eyes-free manner is where the user does not need to look at a display of mobile device 100 to operate mobile device 100. Thus, the hands-free, eyes-free mode allows a user to operate mobile device 100 without touching mobile device 100 and looking at mobile device 100. For example, as will be described in more detail below, a user may answer telephone calls or perform other actions without touching or looking at mobile device 100.

In one embodiment, a movement value is used to activate the hands-free, eyes-free mode. For example, the speed of movement of mobile device 100 is determined. A global positioning satellite (GPS) sensor 102 may be used to determine the speed at which the mobile device is moving. For example, if mobile device 100 is situated in a moving car, GPS sensor 102 is able to determine the speed at which mobile device 100 (and also the car) is traveling. In this situation, mobile device 100 may be stationary in the moving car; however, the car is moving and the speed of movement of the car is measured by GPS sensor 102 of mobile device 100. In one embodiment, the speed of movement measured is different from the acceleration of mobile device 100. Acceleration is the change in velocity of time. The instantaneous speed of an object is the magnitude of its instantaneous velocity or the scalar equivalent of velocity. In one embodiment, the speed of movement may be the instantaneous speed of mobile device 100. However, in other embodiments, speed (absolute number hit), acceleration, weight (e.g., weight of someone sitting in a seat), and presence (e.g. IR or motion sensors), touch (e.g. steering wheel may be used.

GPS sensor 102 may communicate with satellites to determine the speed of movement. In one example, GPS sensor 102 may calculate the speed using algorithms that compute speed by a combination of movement per unit time and computing the doppler shift (e.g., the difference between the expected frequency of the satellite signal and the actual frequency of the incoming signal) in the signals from the satellites.

A mode controller 104 then uses the movement value to determine if the hands-free, eyes-free mode should be activated. For example, when the movement value passes a certain threshold, then the hands-free, eyes-free mode may be activated. In one example, if the movement value indicates mobile device 100 is moving at a speed greater than a programmed threshold (e.g., 5 miles per hour (mph)), then mode controller 104 may activate the hands-free, eyes-free mode.

In one example, a user may set a monitoring phase that will monitor whether the hands-free, eyes-free mode should be activated. For example, the user may enable an application on mobile device 100 to perform the monitoring actively or in the background. The monitoring may be performed while mobile device 100 is in a turned on mode or a powered down mode. The powered down mode may be when mobile device 100 is in a stand by or low power mode. In the monitoring phase, mode controller 104 may communicate with a transceiver 108 to intercept telephone calls that are received and determine which mode should be used to answer the telephone call. For example, if mobile device 100 is traveling at a speed of movement greater than the threshold, then the hands-free, eyes-free mode may be activated. If the speed of movement is not greater than the threshold, then the telephone call may be processed normally.

A processor 106 may be used to control operations of mobile device 100. For example, processor 106 interacts with a speech recognizer 108 and a speech synthesizer 110. Speech recognizer 108 is configured to recognize utterances of a user, such as phrases or words, received from microphone 112. Speech recognizer 106 may convert the speech into a digital form that can be processed. A person of skill in the art will recognize how to recognize speech according to the teachings and disclosures herein.

Speech synthesizer 108 is configured to output utterances, such as words or phrases, through a speaker 114. Speech synthesizer 108 may synthesize words or phrases and output them through microphone 112. A person of skill in the art will recognize how to synthesize speech according to the teachings and disclosures herein. The use of speech synthesizer 108 and speech recognizer 106 will be described in more detail below.

In one example as will be described in more detail below, when in the hands-free, eyes-free mode, speaker 114 is used to output announcements to a user requesting input from the user. For example, speaker 114 may announce that a telephone call has been received from a caller. Microphone 112 may then be used to receive a voice command from the user. Processor 106 may then process the voice command. For example, the user may request that the call be answered and then the call is answered. Speaker mode may be enabled when the call is answered where the speech from the caller is output through speaker 114. In this case, the user does not need to touch or look at mobile device 100 to answer the call. Other actions may also be performed using the hands-free, eyes-free mode, and will be described in more detail below.

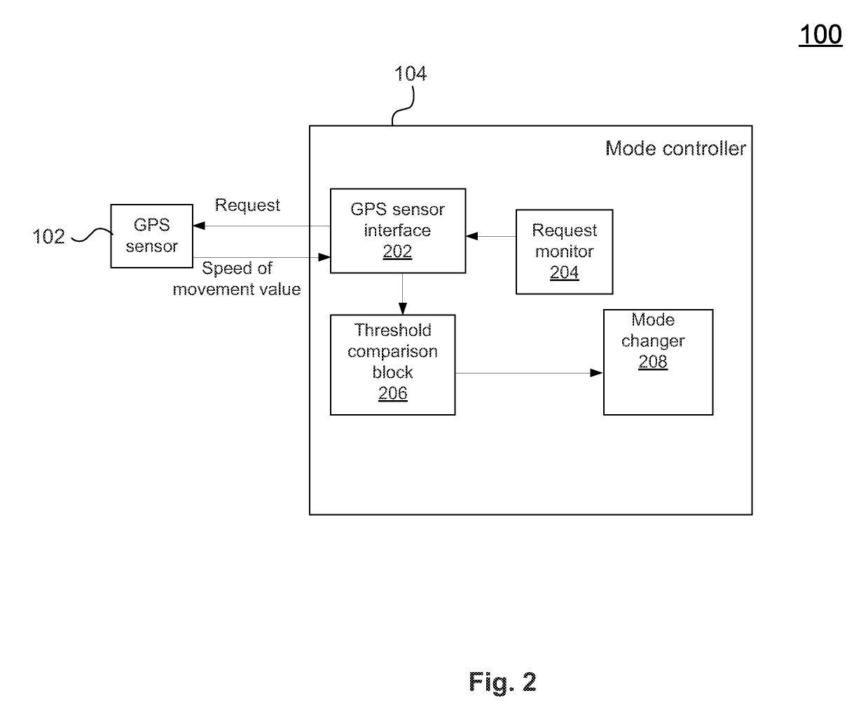

FIG. 2 depicts a more detailed example of mode controller 104 according to one embodiment. Mode controller 104 may interact with GPS sensor 102. Although a GPS sensor is being described, other methods of determining the speed of movement of mobile device 100 may be used. A GPS sensor interface 202 is used to interact with GPS sensor 102. For example, GPS sensor interface 202 may send a request for a speed of movement value from GPS sensor 102. When GPS sensor 102 receives the request, GPS sensor 102 determines the speed of movement for mobile device 100 and sends the speed of movement value back to GPS interface 202.

GPS sensor interface 202 may send the request at different times. For example, a request monitor 204 is used to determine when requests are sent. In one example, request monitor 204 may determine that a request should be sent when a telephone call is received at mobile device 100. Requests may also be sent at other times, such as periodically or when other events occur.

In another embodiment, GPS sensor 102 may send the speed of movement value to GPS sensor interface 202 without receiving a request. For example, GPS sensor 102 may send the speed of movement value periodically. Also, when the speed of movement becomes a non-zero value (i.e., when movement is detected), then GPS sensor 102 may send the speed of movement value periodically. Additionally, GPS sensor 102 may send an indication to GPS sensor interface 202 that the speed of movement value is above a certain amount and this can prompt GPS sensor interface 202 to start sending requests upon an event occurring.

When the speed of movement value is received at GPS interface 202, a threshold comparison block 206 is used to compare the speed of movement value to a threshold. The threshold may be a programmable value that may be set at any value. The value may be set by a user of mobile device 100 or by another party. In one example, the threshold may be expressed in miles per hour or another unit of speed measurement. For example, the threshold may be set to a value (e.g., 5 mph) that would indicate that the user of mobile device 100 is in a moving object.

Threshold comparison block 206 may output a control signal based on the comparison. For example, when the speed of movement value passes the threshold (e.g., goes above the threshold), then threshold comparison block 206 may output a signal to a mode changer 208 indicating that the speed of movement value has passed the threshold. For example, if the threshold is 5 miles per hour, when the speed of movement value goes above 5 miles per hour, then mode changer 208 is notified that the threshold has been passed. Mode changer 208 may then change the mode of operation to the hands-free, eyes-free mode.

Different uses for the hands-free, eyes-free mode will now be described. A general method will be described using the hands-free, eye-free mode and then more specific methods, such as answering telephone calls, will be described.

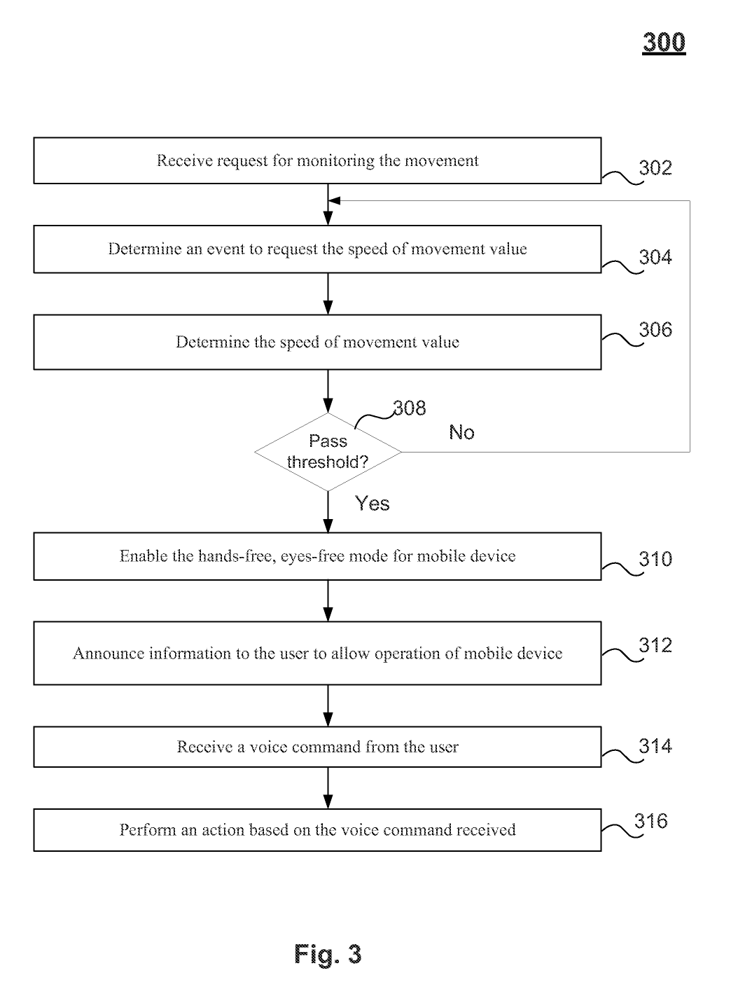

FIG. 3 depicts a simplified flowchart 300 of a method for enabling the hands-free, eyes-free mode according to one embodiment. At 302, a request for monitoring the movement is received. For example, a user may activate monitoring for the hands-free, eyes-free mode. In one example, if activated, at some point, the mode may become enabled. However, if not activated, then the hands-free, eyes-free mode may not be enabled. The activation may be an indication by a user that possible enabling of the hands-free, eyes-free mode is desired. The activation may be set by invoking an application for the hands-free, eyes-free mode, where the application may run in the background or be actively running on mobile device 100. When the input is received, then request monitor 204 may cause the application to read the speed of movement value from GPS sensor 102 when an event occurs and then perform any other action in the hands-free, eyes-free mode.

At 304, an event to request the speed of movement value is determined. For example, the event may be the activation, a telephone call, an internal trigger (e.g., when monitoring is performed periodically), a trigger phrase, or other events.

At 306, mode controller 104 determines the speed of movement value. For example, a request may be sent to GPS sensor 102 for the speed of movement value. GPS sensor 102 would then measure the speed of movement of mobile device 100.

When the speed of movement value is received, at 308, mode controller 104 determines if the speed of movement value has passed the threshold. For example, it is determined if the speed of movement value of mobile device 100 is greater than a certain speed.

If the speed of movement value has not passed the threshold, the process may reiterate to 304 to wait for another event to occur. For example, another telephone call may be received. Also, if the speed of movement value has not passed the threshold, other actions may be performed with mobile device 100, such as a user may answer the telephone call using normal methods, such as picking up the telephone and answering the call by pressing an answer call button.

If the speed of movement value is above the threshold, at 310, mode controller 104 enables the hands-free, eyes-free mode for mobile device 100.

At 312, mobile device 100 announces information to the user to allow operation of mobile device 100. For example, information is output such that the user does not need to look at mobile device 100.

At 314, mobile device 100 receives a voice command from the user. For example, microphone 112 may receive a phrase from the user. Speech recognizer 108 may recognize a phrase and provide the phrase to processor 106.

At 316, mobile device 100 performs an action based on the voice command received. For example, processor 106 may process the voice command based on recognition of the phrase received.

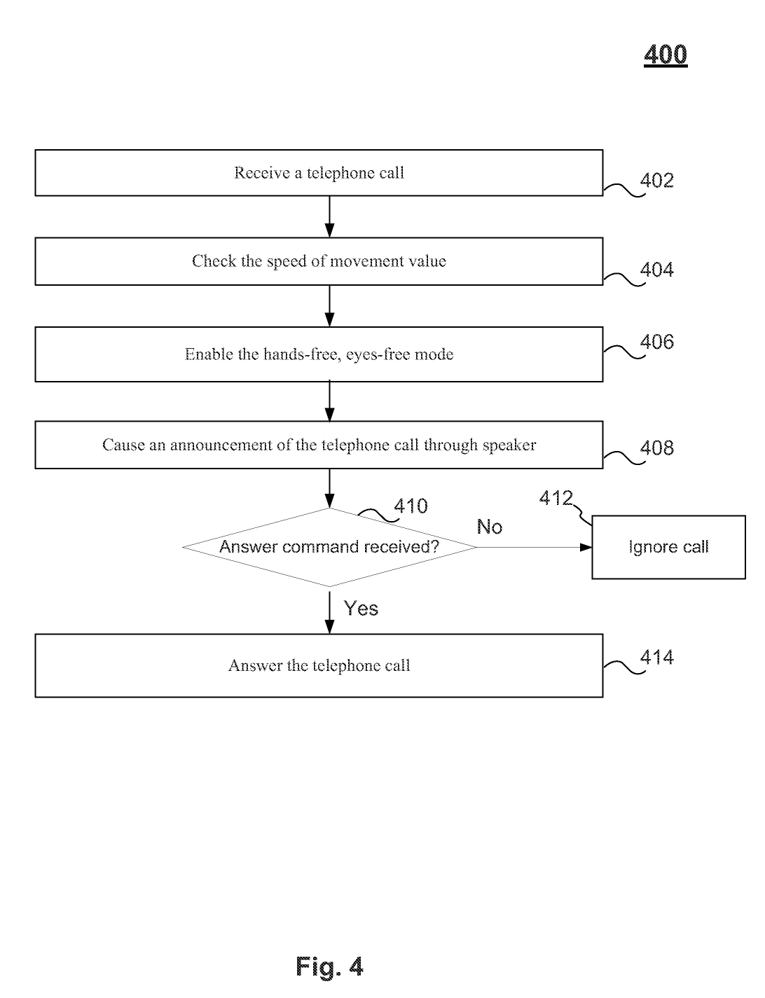

The hands-free, eyes-free mode may be used to process telephone calls along with performing other actions. A specific example for receiving a telephone call will now be described. FIG. 4 depicts a simplified flowchart 400 of a method for answering a telephone call using the hands-free, eyes-free mode according to one embodiment. The method assumes that a user has activated monitoring for enabling the hands-free, eyes-free mode.

At 402, mobile device 100 receives a telephone call. For example, the telephone call may be received through transceiver 108. In one embodiment, mode controller 104 may intercept the call handling of a telephone call. In this case, the telephone does not ring until mode controller 104 releases the call handling for further processing.

At 404, mode controller 104 checks the speed of movement value. For example, as described below, GPS sensor 102 may be queried for the speed of movement value. It is assumed in this case, that a comparison indicates that the speed of movement value is above the threshold. Although the check and comparison are described, the check and comparison may have been performed before the telephone call was received. For example, once the speed of movement of mobile device 100 went over the threshold, it may be noted (e.g., a flag is set) that the hands-free, eyes-free mode should be enabled upon receiving a telephone call.

At 406, mode controller 104 enables the hands-free, eyes-free mode. In this case, actions are performed such that the user does not need to look at mobile device 100 or touch mobile device 100. In one example, the speaker telephone is enabled in mobile device 100. Also, in one case, the volume settings for mobile device 100 may also be overridden. For example, the volume settings to output audio from speaker 114 may be increased such that the user can hear any announcements. Also, if mobile device 100 is in a mode that does not allow audible announcements, such as a silent mode or vibrate mode, this mode may be overridden. Although these modes may be overridden, it should be noted that the user can configure mode controller 104 to not override these modes.

At 408, mobile device 100 causes an announcement of the telephone call through speaker 114. The announcement may be generated through speech synthesizer 110 and may include the caller ID of a caller for the telephone call. An example announcement may be “You have received a telephone call from <Caller ID information>. Would you like to answer the call?” The caller ID information may be determined from the incoming caller's telephone number. The name of the caller is then looked up in the address book of mobile device 100 and inserted into the announcement. If a name cannot be found, the telephone number may be announced.

At 410, mobile device 100 determines if the answer command was received. For example, speech recognizer 108 may listen for certain utterances, such as words or phrases, that could be received from the user. For example, the user may indicate that the call should be answered with an answer command. The answer command may be “answer telephone” or “yes”. Also, ignoring the telephone call may be associated with the phrases “ignore” or “no”. Other words or phrases may also be used.

In one example, speech recognizer 108 may be able to distinguish voice commands while in a noisy environment. For example, when a user is riding in a moving car, the background noise may be very loud due to wind, radio, or other noises. Speech recognizer 108 may distinguish voice commands from the undesirable noise to improve performance.

If the answer command is not received, then, at 412, mobile device 100 may ignore the call. For example, the telephone call may be sent to voicemail or other actions may be performed other than answering the telephone call.

If the answer command is received, at 414, mobile device 100 answers the telephone call. For example, if call handling was interrupted by mode controller 104, the call handling is released. Then, processor 106 may connect the caller with the user. At 416, mobile device 100 enables the speaker telephone for the call. In this case, the speaker telephone is used in the telephone conversation.

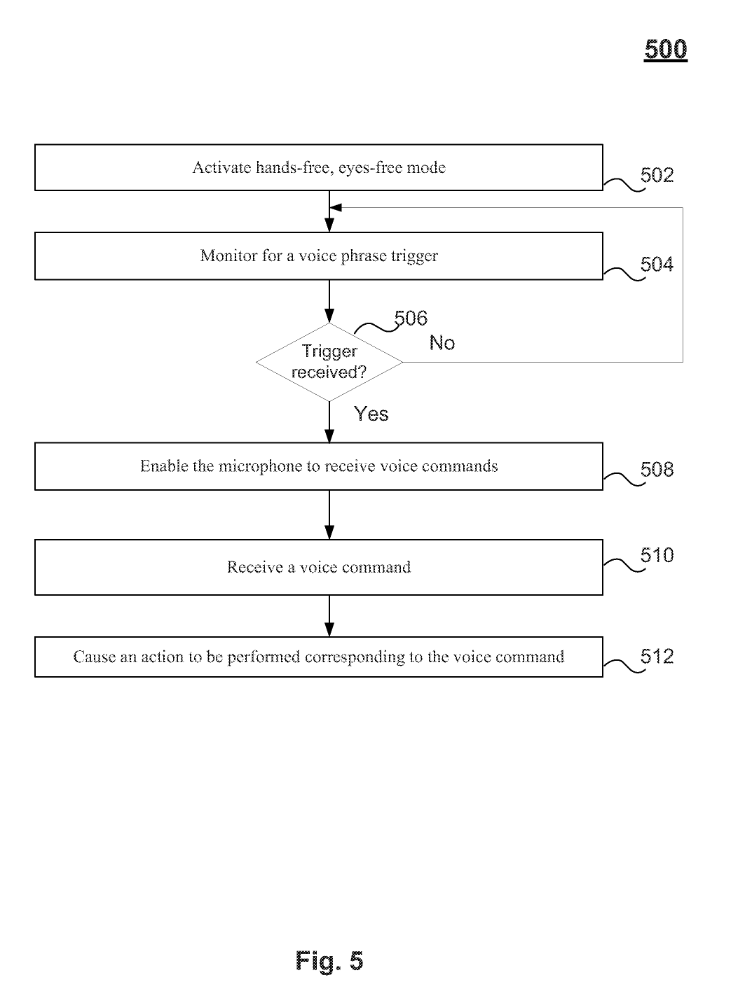

Mobile device 100 may also use the hands-free, eyes-free mode to receive commands when not processing telephone calls. FIG. 5 depicts a simplified flowchart 500 of a method for receiving voice commands in the hands-free, eyes-free mode according to one embodiment.

At 502, the hands-free, eyes-free mode is activated. For example, a user may have activated the request monitoring and the speed of movement may have surpassed the threshold. At this point, the hands-free, eyes-free mode may remain enabled until the speed of movement goes below the threshold. At that point, the hands-free, eyes-free mode may be disabled. This process may continue as the speed of movement is detected over various intervals.

At 504, mobile device 100 monitors for a voice phrase trigger. For example, mobile device 100 may be put into a mode in which certain voice phrases can trigger enablement of the hands-free, eyes-free mode. For example, a phrase such as “wake up telephone” may be used to trigger the hands-free, eyes-free mode. For example, mobile device 100 may, when not in use, transition to a powered-down mode or standby mode. In the powered-down mode, mobile device 100 may still be on but may not be active. In this case, a trigger may be used to power up mobile device 100. Also, using the voice phrase trigger also does not cause false positives when other conversation around mobile device 100 occurs. For example, a user may not want to have an action performed using mobile device 100 and thus needs to enable mobile device 100 to receive voice commands.

At 506, mobile device 100 determines if the voice phrase trigger is received. If not, the process may reiterate to continue monitoring. In one embodiment, the monitoring may be performed while mobile device 100 is in the active, standby, or powered-down mode.

If the voice phrase trigger is received, at 508, mobile device 100 enables microphone 112 to receive voice commands For example, any recognized voice commands that are now received will be processed by mobile device 100.

At 510, mobile device 100 receives a voice command. For example, microphone 112 may receive an utterance, which is recognized by speech recognizer 108. Processor 106 may then determine what the voice command represents.

At 512, mobile device 100 then causes an action to be performed corresponding to the voice command. For example, various voice commands may correspond to different actions. Once the voice command is recognized, a corresponding action is looked up and the action may then be performed. In one example, once the hands-free, eyes-free mode is enabled after the voice trigger is received, the user may request that a telephone call be made. While the telephone call is being requested, mobile device 100 may also make announcements through speaker 114. For example, if a question needs to be asked, then speech synthesizer 110 will synthesize the announcement and output it through speaker 114. This may take the place of any actions that a user previously would have had to look at or touch mobile device 100.

In one example, the user may want to look up a telephone number of a restaurant. The user would enable the hands-free, eyes-free mode by stating the voice phrase trigger of “Wake up telephone.” The user would then speak the voice command “What is the telephone number to restaurant <restaurant name>?” Mobile device 100 may interpret this voice command with a search for the telephone number of the restaurant. Once the restaurant telephone number is found, then mobile device 100 outputs an announcement through speaker 114 with the restaurant's telephone number. For example, the announcement may be “The restaurant's telephone number is 123-4567.” Thus, the user has performed a search on mobile device 100 and does not need to look at the result on mobile device 100, but rather is announced the result making the search hands-free and eyes-free.

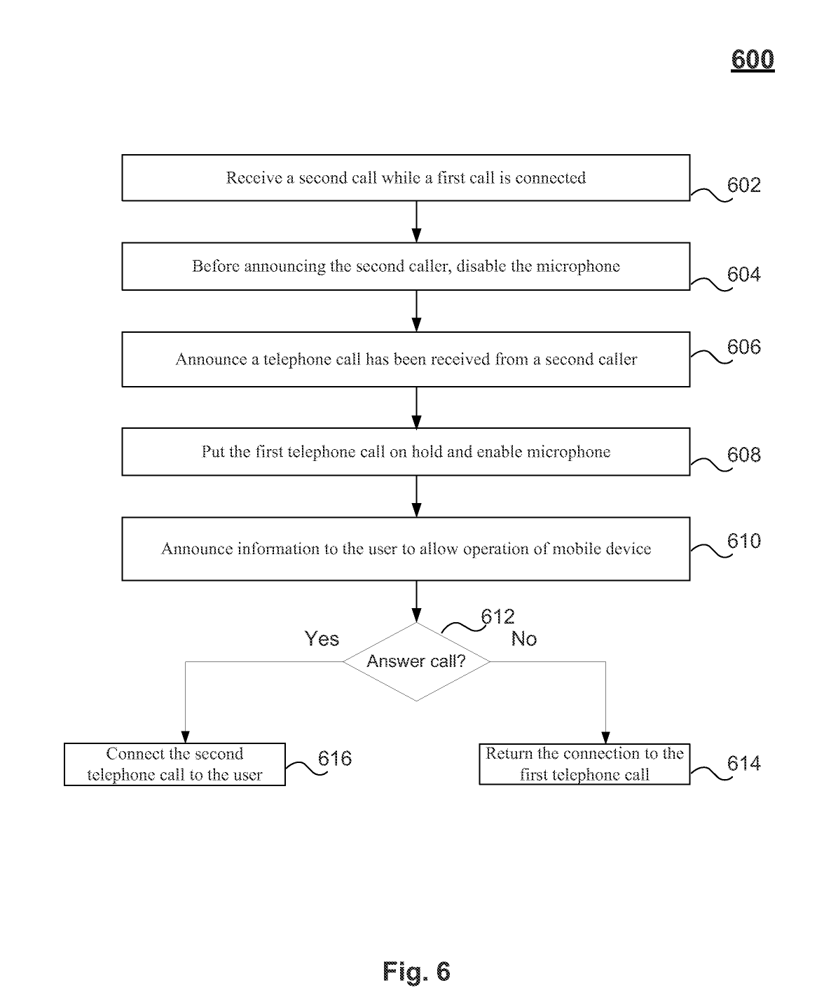

Mobile device 100 may also be used to answer a second call that is received. FIG. 6 depicts a simplified flowchart 600 of a method for processing a second call while a first call has been connected according to one embodiment. At 602, a second call is received while a first call is connected. For example, the user may be on a telephone call with a first caller. The first telephone call may have been connected via the hands-free, eyes-free mode. However, it is not necessary that the first telephone call was connected via the hands-free, eyes free mode. For example, while the user is connected to the first telephone call, the speed of movement of mobile device 100 may exceed the threshold thus activating the hands-free, eyes-free mode.

To answer the second telephone call, speaker 114 needs to be used to announce the receiving of the second telephone call. This is because the eyes-free mode should not require that the user look at mobile device 100 to determine who the second caller is. Before announcing the second caller, at 604, microphone 112 may be disabled. Microphone 112 is disabled because particular embodiments do not want the first caller to hear the announcement that the second caller is calling. At 606, once microphone 112 is disabled, speaker 114 announces a telephone call has been received from a second caller.

At 608, the first telephone call may be put on hold and microphone 112 is enabled. This allows a voice command to be received from the user. At 610, a voice command may be received regarding the second call. If a voice command that is received indicates that the second call should be ignored, at 610, mobile device 100 returns the connection to the first telephone call.

At 612, if the user desires to answer the second telephone call, mobile device 100 connects the second telephone call to the user. The first telephone call may be put on hold or may be disconnected.

Accordingly, a hands-free, eyes-free mobile device 100 is provided. The hands-free, eyes-free mode is enabled based on speed of movement detected. The speed of movement may be detected using a GPS sensor. The hands-free, eyes-free mode allows a user who may be driving a car or any other moving vehicle to perform actions with mobile device 100. For example, telephone calls may be answered. Also, effectively, a car kit is provided in which the user can interact with mobile device 100 to have other actions performed.

By providing the hands-free, eyes-free mode, a user may not need to purchase a Bluetooth headset. For example, to use mobile device 100 in a moving vehicle, the user would not have to activate a Bluetooth headset. Additionally, use of a Bluetooth headset may also require the user to move their hands off of the steering wheel and thus may be more dangerous than using the hands-free, eyes-free mode of mobile device 100.

Particular embodiments can be implemented in the form of control logic in software or hardware or a combination of both. The control logic, when executed by one or more computer processors, may be operable to perform a method described in particular embodiments. A “computer-readable storage medium” for purposes of particular embodiments may be any medium that can store instructions or control logic for controlling the one or more computer processors to perform a method described in particular embodiments in connection with an instruction execution computer system, apparatus, or device.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents may be employed without departing from the scope of the invention as defined by the claims.

What is claimed is:

1. A method comprising:
determining an event at a mobile device;
determining a movement value for a speed of movement of the mobile device based on the event;
comparing the movement value to a threshold; and
if the movement value has passed the threshold, enabling a mode such that the mobile device is configured to announce information to a user of the mobile device and configured to receive an audible command from the user of the mobile device.

2. The method of claim 1, wherein determining the movement value comprises determining the movement value using a global positioning satellite (GPS) sensor in the mobile device.

3. The method of claim 1, wherein the mode comprises a hands-free, eyes-free mode that allows the user to operate the mobile device without touching or looking at the mobile device.

4. The method of claim 3, wherein the hands-free, eyes-free mode announces information normally displayed on a screen of the mobile device and receives audible commands instead of physical selections from the user on the mobile device.

5. The method of claim 1, wherein the event comprises a telephone call, the method further comprising:
if the movement value has passed the threshold, providing an audible output announcing the telephone call.

6. The method of claim 5, further comprising overriding a volume setting in the mobile device to increase speaker volume to provide the audible output.

7. The method of claim 5, further comprising:
receiving a voice command from the user to answer the telephone call; and
automatically answering the telephone call.

8. The method of claim 7, further comprising automatically activating a speaker of the mobile device for the telephone call.

9. The method of claim 5, wherein the telephone call comprises a first telephone call, the method further comprising:
receiving a second telephone call;
disabling a microphone of the mobile device;
outputting a second audible output announcing the second telephone call; and
receiving a command from the user for handling of the second telephone call.

10. The method of claim 1, further comprising:
receiving a voice trigger phrase configured to activate the mobile device to receive voice commands; and
enabling the mobile device to receive the voice commands.

11. The method of claim 1, wherein the event comprises receiving an activation of the mode for monitoring the movement of the mobile device.

12. A computer-readable storage medium containing instructions for controlling a computer system to perform a method, the method comprising:
determining an event at a mobile device;
determining a movement value for a speed of movement of the mobile device based on the event;
comparing the movement value to a threshold; and
if the movement value has passed the threshold, enabling a mode such that the mobile device is configured to announce information to a user of the mobile device and configured to receive an audible command from the user of the mobile device.

13. The computer-readable storage medium of claim 12, wherein determining the movement value comprises determining the movement value using a global positioning satellite (GPS) sensor in the mobile device.

14. The computer-readable storage medium of claim 12, wherein the movement monitoring mode comprises a hands-free, eyes-free mode that allows the user to operate the mobile device without touching or looking at the mobile device.

15. The computer-readable storage medium of claim 12, wherein the hands-free, eyes-free mode announces information normally displayed on a screen of the mobile device and receives audible commands instead of physical selections from the user on the mobile device.

16. The computer-readable storage medium of claim 12, wherein the event comprises a telephone call, the method further comprising:
if the movement value has passed the threshold, providing an audible output announcing the telephone call.

17. The computer-readable storage medium of claim 16, further comprising:
receiving a voice command from the user to answer the telephone call; and
automatically answering the telephone call

18. The computer-readable storage medium of claim 17, further comprising activating a speaker of the mobile device for the telephone call.

19. The computer-readable storage medium of claim 12, further comprising:
receiving a voice trigger phrase configured to activate the mobile device to receive voice commands; and
enabling the mobile device to receive the voice commands.

20. An apparatus comprising:
one or more computer processors; and
a computer-readable storage medium comprising instructions for controlling the one or more computer processors to perform a method, the method comprising:
determining an event at a mobile device;
determining a movement value for a speed of movement of the mobile device based on the event;
comparing the movement value to a threshold; and
if the movement value has passed the threshold, enabling a mode such that the mobile device is configured to announce information to a user of the mobile device and configured to receive an audible command from the user of the mobile device.
